(19) United States
(12) Patent Application Publication
(10) Pub. No.: US 2024/0198261 A1
(43) Pub. Date: Jun. 20, 2024

(54) FILTER MESH

(71) Applicant: Markert Filtration GmbH, Hamburg (DE)

(72) Inventors: Philipp Trautmann, Neumuenster (DE); Mirko Duevell, Bargteheide (DE)

(21) Appl. No.: 18/513,571

(22) Filed: Nov. 19, 2023

(30) Foreign Application Priority Data
Dec. 14, 2022 (DE) 102022133357.4

(51) Int. Cl. B01D 39/08; B01D 25/12; D03D 1/00; D03D 9/00; D03D 15/283; D03D 15/47

(52) U.S. Cl. CPC B01D 39/083; B01D 25/12; D03D 1/00; D03D 9/00; D03D 15/283; D03D 15/47; B01D 2239/0208; B01D 2239/0216; D10B 2321/0211; D10B 2321/022; D10B 2403/0114; D10B 2505/04

(57) ABSTRACT

A filter mesh is provided that has warp threads and weft threads which are crosswise interwoven and together form a filter cloth having one side facing a filter cake when being in a position of use and one side facing a filtrate drain side. At least some of the warp threads are made of an ultra-high molecular weight polyethylene. For example, at least 25% of the warp threads are made of ultra-high molecular weight polyethylene.

### BACKGROUND

The present invention relates to a filter mesh having warp threads and weft threads which are crosswise interwoven and together form a filter cloth having one side facing the filter cake when being in the position of use and one side turned away from the filter cake, wherein at least some of said warp threads of such filter mesh are made of ultra-high molecular weight polyethylene (UHMWPE threads).

In filter presses, a filter plate is arranged on the side turned away from the filter cloth. But this side may also feature a clearance, wherein the filtrate drains into. Hereinafter, this patent will also refer to a filtrate drain side without any intention to imply any restriction.

A filter mesh of this type is known from EP 2 185 264 B1. In said mesh, wadding threads made of ultra-high molecular weight polyethylene are worked in every 1 cm to 10 cm and in parallel to the weft threads and in parallel to the warp threads in order to prevent or at least to reduce any bulging of said filter cloth while in operation.

Yarns and threads made of ultra-high molecular weight polyethylene are generally known and feature excellent properties with respect to cut resistance and resistance to extension. Moreover, such yarns are relatively abrasion-resistant. They are often used in protective clothing, ropes, and cords. Such resistance is due to an important molar mass of 3,000 kg/mol to 6,000 kg/mol. Conventional high-density polyethylene has mol masses from 200 kg/mol to 500 kg/mol.

It has turned out that service life of filter clothes filtering abrasive media or suspensions, such as for example when processing ores, is limited due to important wear. Threads forming such cloth wear out quickly due to constant strain caused by abrasive media. Such filter mesh respectively filter cloth becomes permeable and therefore unfit. Therefore, such filter clothes must be replaced relatively often in order to provide a satisfactory filtering result. This entails high operational costs.

### SUMMARY

The present invention is based on the object to form a filter mesh of the aforedescribed type such that enhanced resistance to wear will be achieved.

This object is solved according to the invention by at least 25% of said warp threads being made of ultra-high molecular weight polyethylene (UHMWPE threads). Such warp threads made of ultra-high molecular weight polyethylene can, in principle, be provided in any order or, preferably be evenly distributed within such filter mesh. For example, it can be provided that every fourth warp thread is made of ultra-high molecular weight polyethylene (UHMWPE threads). Thereby, the percentile of UHMWPE threads in warp threads amounts to 25%. Given a thread size of approximately 0.3 mm and a warp thread distance of approximately 0.05 mm, such mesh therefore features one warp thread made of ultra-high molecular weight polyethylene every 0.35 mm. It has turned out that such an important UHMWPE warp thread percentile enables significant improvement of resistance to wear of such filter mesh.

It can be provided that all warp threads or more than 90% of such warp threads are made of ultra-high molecular weight polyethylene. But in this case, it is more time-consuming and expensive to get said filter mesh into shape, as said UHMWPE threads are relatively soft. Hence, the invention preferably provides that between 60% and 70% or between 45% and 55% or between 30% and 35% of said warp threads are made of ultra-high molecular weight polyethylene. This can for example be achieved by every second and every third or only every second or only every third warp thread is made of an ultra-high molecular weight polyethylene. This corresponds to a warp thread percentile made of UHMWPE threads of 66.67%, 50.0% respectively 33.33%.

The remaining warp threads can be made of polyolefin and in particular of polypropylene. Said warp threads can be present in said filter mesh in any order or evenly distributed. In such filter mesh featuring the aforementioned percentiles of UHMWPE warp threads, every third or every second warp thread or every second and every third warp thread or every second, third, and fourth warp thread is preferably made of polyolefin and in particular of polypropylene. But said warp threads can also be formed from polyamide yarns or polyester yarns. The bigger the percentile of warp threads made of ultra-high molecular weight polyethylene, the higher the resistance to abrasion and wear.

According to one preferred embodiment of the invention, it is therefore provided that said warp threads and said weft threads are interwoven such that a bigger sub-section of said warp threads, when being in the position of use, flow on the side facing the filter cake than on the side of said filter cloth turned away from the filter cake. When being in the position of use, such a weave type therefore features more material made of ultra-high molecular weight polyethylene on the side of the filter cloth facing the filter cake than on the opposite side which is facing the filter plate. Therefore, said filter cloth exhibits enhanced resistance to wear on this side and service life of said filter cloth is extended.

Said filter mesh can be woven in the shape of a twill binding known as such. In this way, it can be provided that one warp thread skips over two or three or more adjacent weft threads on the top side and then skips under only one weft thread on the bottom side. Thereby, said warp thread is interrupted on the top side only by every third or every fourth weft thread. Hence, there flows a bigger sub-section of said warp thread than on the bottom side of said filter mesh. In the position of use, the top side forms the side of said filter cloth facing the filter cake. Basically, any other weave types, such as satin weave, can also be used. Therefore, said wear-resistant UHMWPE threads predominantly flow on the side facing said filter cake and subjected to said abrasive material. Therefore, the wear resistant properties of the UHMWPE threads are used to their full capacity.

Those warp threads which are not made of ultra-high molecular weight polyethylene can be interwoven with the weft threads according to the intended weave type. But it can also be provided that only those warp threads made of ultra-high molecular weight polyethylene flow on the side facing the filter cake over two or several adjacent weft threads and under only one weft thread on the side turned away from the filter cake. Thereby, it can also be provided that at least one warp thread made of a polyolefin or a polypropylene flows on the side facing the filter cake over a weft thread and on the side facing the filtrate drain side over two or several parallel weft threads. In this case, the side facing the filter cake in the position of use of the filter cloth is in major part made of ultra-high molecular weight polyethylene.

Furthermore, it can be provided that the weft threads are made of polyolefin and in particular of polypropylene. But even polyamide yarns or polyester yarns can be used as weft threads. In this case, said weft threads can be made at least in part of monofilament threads which are easier to process and are moreover more cost-efficient than of UHMWPE threads. Said warp threads can at least in part be multifilament threads.

According to one possible embodiment of the invention, it is provided that only said warp threads are made entirely or partially made of ultra-high molecular weight polyethylene, whereas said weft threads are made of a different material and in particular of polyolefin, polypropylene, polyamide, or polyester.

When it is made of this type of filter mesh, a filter cloth becomes significantly more wear resistant. Hence, this enables reduction of operation costs. As only some of said weaving threads and preferably only some of said warp threads are made of ultra-high molecular weight polyethylene, said filter cloth remains relatively cost-efficient.

Said filter cloth according to the invention is particularly suitable for use in filter presses. In this case, the side having the bigger percentile of UHMWPE threads faces the filter cake formed during operation, whereas the other side having the smaller percentile of UHMWPE threads faces the filter plate of said filter press. This side is not directly contacted by the medium to be filtered and is thereby not subjected to such an important wear.

### BRIEF DESCRIPTION OF THE DRAWINGS

Hereinafter, the invention shall be explained by means of the schematic drawings. The drawings show:

FIG. 1 is a top view of a filter mesh according to the invention; and

FIG. 2 is a sectional view in the direction of said warp threads through said filter mesh of FIG. 1.

### DETAILED DESCRIPTION

Said filter mesh 10 some extracts of which are shown in the drawing exhibits warp threads 11, 12 flowing in parallel to each other in the warp direction 13. Said weft threads 14 flow perpendicularly to this in the weft direction 15.

The embodiment shown represents a twill binding 2/1 (twill 2 over 1 under), where one warp thread 11, 12 skips over two weft threads 14 directly adjacent to each other in a first step and subsequently skips under one weft thread 14, and so on. Basically, different weave types can also be considered, such as twill 3/1 (twill 3 over 1 under) or a satin weave. Moreover, a plain weave is also possible.

Said warp threads 11 are made of ultra-high molecular weight polyethylene yarn. The warp threads 12 can be made of a polyolefin and in particular of polypropylene. Hence, 50% of said warp threads in the embodiment shown are made of ultra-high molecular weight polyethylene yarn. The weft threads 14, too, are made of a polyolefin, par example of polypropylene. Owing to said UHMWPE threads 11 provided and weft in said filter mesh 10, said filter cloth is given enhanced resistance to wear with respect to abrasive media.

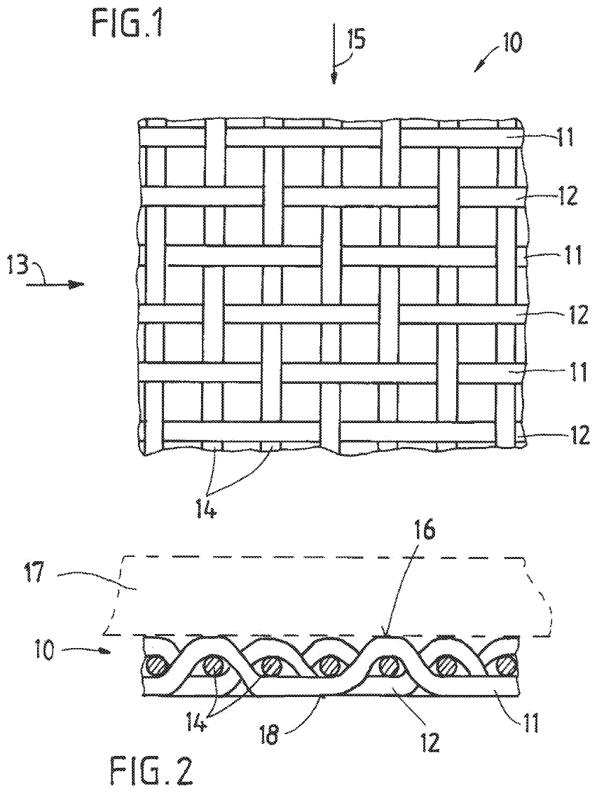

In the position of use, said filter mesh 10 is adjacent to a filter plate 17 not shown in detail with one of its sides 16. Thereby, said side 16 of said filter mesh 10 corresponds to the bottom side of the mesh shown in FIG. 1. Only one filter plate 17 is shown in the drawing. Even a clearance or any other support facility, such as a disc segment of disc filters, a drum wall of drum filters or a sieve of flat filters can be provided there. In the position of use, said side 16 is turned away from the filter cake 18 and is also referred to as filtrate drain side.

In the position of use, a major sub-section or length section of all warp threads 11, 12 is arranged on the side 18 of said filter mesh 10 opposite to the filter drain side. This side 18 faces the filter cake and is hence subjected to increased abrasive strain when being in the position of use.

As shown in the drawing, the weave type chosen enables a relatively bigger amount of material made of ultra-high molecular weight polyethylene to face said filter cake than facing said filtrate drain side of said filter cloth. Hence, wear resistance properties of said ultra-high molecular weight polyethylene are used to their full capacity.

We claim:

1. A filter mesh having warp threads (11, 12) and weft threads (14) which are crosswise interwoven and together form a filter cloth having one side (18) facing a filter cake when being in the position of use and one side turned away (16) from the filter cake, wherein at least some of said warp threads (11) of such filter mesh (10) are made of ultra-high molecular weight polyethylene, wherein at least 25% of said warp threads (11) are made of ultra-high molecular weight polyethylene.

2. The filter mesh according to claim 1, wherein between 60% and 70%, between 45% and 55%, or between 30% and 35% of said warp threads are made of ultra-high molecular weight polyethylene.

3. The filter mesh according to claim 2, wherein said warp threads (11) made of ultra-high molecular weight polyethylene are evenly distributed within said filter mesh.

4. The filter mesh according to claim 1, wherein said warp threads (11) made of ultra-high molecular weight polyethylene are evenly distributed within said filter mesh.

5. The filter mesh according to claim 1, wherein every second and every third or every second or every third or every fourth warp thread (11) is made of ultra-high molecular weight polyethylene.

6. The filter mesh according to claim 1, wherein all warp threads (11, 12) or more than 90% of such warp threads (11, 12) are made of ultra-high molecular weight polyethylene.

7. The filter mesh according to claim 1, wherein warp threads not made of ultra-high molecular weight polyethylene and in particular every third warp thread (12) or every second warp thread (12) or every second and every third warp thread (12) or every second, third, and fourth warp thread (12) are made of polyolefin.

8. The filter mesh according to claim 7, wherein the polyolefin is polypropylene.

9. The filter mesh according to claim 1, wherein said warp threads (11, 12) and said weft threads (14) are interwoven such that a bigger sub-section of said warp threads (11,12), when being in the position of use, flow on the side (18) facing the filter cake than on the side (16) of said filter mesh (10) turned away from the filter cake.

10. The filter mesh according to claim 1, wherein said warp threads (11, 12) are interwoven via a twill binding with the weft threads (14) such that at least one warp thread (11, 12) flows on the side (18) facing said filter cake over two or several adjacent weft threads (14) and on the side (16) turned away from the filter cake under a weft thread (14).

11. The filter mesh according to claim 1, wherein at least the warp threads (11) made of ultra-high molecular weight polyethylene flow on the side (18) facing the filter cake flow over two or several adjacent weft threads (14) and on the side (16) turned away from the filter cake under a weft thread (14).

12. The filter mesh according to claim 1, wherein said weft threads (14) are made of a polyolefin.

13. The filter mesh according to claim 12, wherein the polyolefin is polypropylene.

14. The filter mesh according to claim 1, wherein the warp threads (11) are at least in part multifilament threads.

15. The filter mesh according to claim 1, wherein said weft threads (14) are at least in part monofilament threads.

16. The filter mesh according to claim 1, wherein only said warp threads are in part or totally made of ultra-high molecular weight polyethylene.

17. A filter press having a filter cloth made of the filter mesh according to claim 1.

18. The filter press according to claim 14, wherein, when the filter cloth is in a mounted position, the side having the bigger percentile of UHMWPE threads faces the filter cake.
